(19) United States
(12) Patent Application Publication
(10) Pub. No.: US 2020/0080355 A1
(43) Pub. Date: Mar. 12, 2020

(54) LATCH DEVICE

(71) Applicant: MARINE TOWN INC., NEW TAIPEI CITY (TW)

(72) Inventor: CHIN-CHUNG TUNG, New Taipei City (TW)

(21) Appl. No.: 16/124,633

(22) Filed: Sep. 7, 2018

(51) Int. Cl. E05C 19/10; E05B 15/02

(52) U.S. Cl. CPC E05C 19/10; E05B 65/52; E05B 15/022

(57) ABSTRACT

A latch device is disposed between a first member and a second member that are pivotally combined. The latch device includes a main body, a hook member, and a moving member. The main body has one side fixed to the first member and a containing groove opening toward an outer side. The hook member is fixed to the second member. The moving member is in the containing groove and slides between a first and a second position. When the moving member is at the first position, the moving member is engaged with the hook member, such that the first member and the second member close. When the moving member is at the second position, the moving member retracts with respect to the main body, such that the moving member is parted from the hook member, whereby the first member and the second member open.

### BACKGROUND OF THE INVENTION

### 1. Field of the Invention

The present invention relates to latch devices, and more particularly, to a latch device applicable to seat cushion structures, lockers, or storage cabinets.

### 2. Description of the Related Art

In a conventional seat cushion structure containing a storage space, a plurality of clamp rings are disposed between the cushion and the seat for combining the cushion and the seat, so as to prevent the cushion to be accidentally opened or lifted with respect to the seat. However, the large amount of clamp rings fail to meet the convenience and efficiency of usage.

Other similar structures apply a handle as well. The handle is used for lifting the cushion and also for clamping the cushion and the seat. However, a handle is usually exposed or protrudes on the outer side of the cushion. Therefore, an improvement of the aesthetic appearance is needed. Also, conventional cushion structure with a handle may accidentally cause collision with human body.

Also, in other cabinet structure having a storage space, a rotatable handle is applied on the cabinet door for clamping a fixing object. However, when opening or closing the cabinet door, the user needs to rotate the handle to operate, failing to meet the convenience of usage.

### SUMMARY OF THE INVENTION

For improving the issues above, a latch device is disclosed, which is installed between two openable components. With a simple pressing, the latching status is removed, such that the two components are allowed to be opened. Therefore, the present invention achieves a simple structure, and the convenience of usage is facilitated.

For achieving the aforementioned objectives, a latch device in accordance with an embodiment of the present invention is provided, which is disposed between a first member and a second member that are pivotally combined, the latch device comprising:

a main body having one side thereof fixed to the first member, the main body having a containing groove opening toward an outer side;

a hook member fixed to the second member; and

a moving member disposed in the containing groove and slidably moving between a first position and a second position with respect to the main body;

when the moving member is at the first position, the moving member is engaged with the hook member, such that the first member and the second member close; when the moving member is at the second position, the moving member retracts with respect to the main body, such that the moving member is parted from the hook member, whereby the first member and the second member open.

With such configuration, when the moving member is presses by the user, the moving member retracts to part the engagement portion from the hook member, such that the first member is allowed to be lifted and open with respect to the second member, facilitating the convenience of usage. Also, the structure of the present invention is relatively simple.

### BRIEF DESCRIPTION OF THE DRAWINGS

FIG. 1 is a perspective view of the latch device in accordance with an embodiment of the present invention installed between the lid and the cabinet, wherein the lid is closed with respect to the cabinet.

FIG. 2 is a perspective view of the latch device in accordance with an embodiment of the present invention installed between the lid and the cabinet, wherein the lid is opened with respect to the cabinet.

FIG. 3 is a schematic view illustrating the structure of the latch device in accordance with an embodiment of the present invention.

FIG. 4 is a transverse sectional view of the latch device, illustrating the resilient assembly resiliently pushing the moving member.

FIG. 5 is a sectional view of the latch device, illustrating the hood member engaged with the engagement portion of the moving member, wherein the moving member is at the first position.

FIG. 6 is a sectional view of the latch device, illustrating the hood member engaged with the engagement portion of the moving member, wherein the moving member is pressed to be positioned at the second position.

FIG. 7 is a sectional view of the latch device, illustrating the hood member disengaged from the engagement portion of the moving member, wherein the first member is lifted to be opened with respect to the second member.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion. Embodiments of the present invention are illustrated in detail along with the drawings. However, the technical features included by the present invention are not limited to certain embodiments hereby provided. Scope of the present invention shall be referred to the claims, which include all the possible replacements, modifications, and equivalent features.

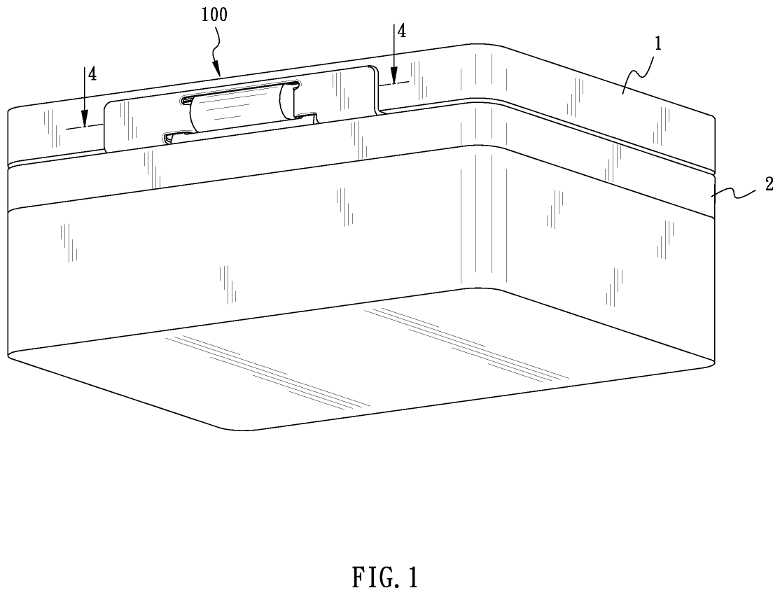

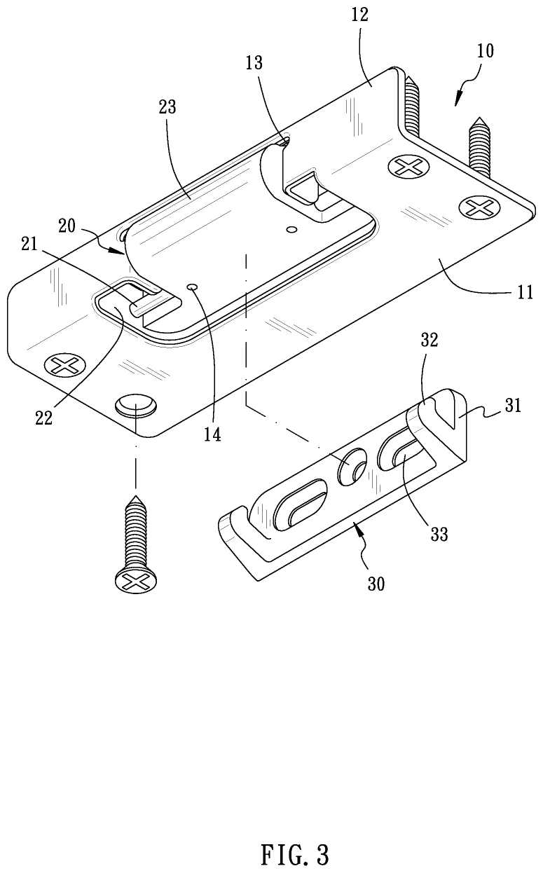

Referring to FIG. 1 to FIG. 7, a latch device 100 is disposed between a first member 1 and a second member 2 that are pivotally combined to each other. In an embodiment of the present invention, the first member 1 is a lid, and the second member 2 is a cabinet having a storage space. The first member 1 and the second member 2 have one side thereof pivotally combined to each other, such that the first member 1 and the second member 2 are allowed to pivotally open with respect to each other. The latch device 100 is disposed on the other side of the first member 1 and the second member 2, respectively, so as to achieve a stable latching effect to facilitate the opening motion of the first member 1 and the second member 2. Therein, the latch device 100 comprises a main body 10, a moving member 20, and a hook member 30.

The main body 10 has an installation face 11 and an outer lateral face 12 vertically connected with the installation face 11. The outer lateral face 12 is approximately parallel to a lateral face of the first member 1. The main body 10 has a containing groove 13 concavely disposed between the installation face 11 and the outer lateral face 12, wherein the containing groove 13 opens toward the outer side from the installation face 11 and the outer lateral face 12. The installation face 11 is fixed to one side of the first member 1 through a screw member or a bolt.

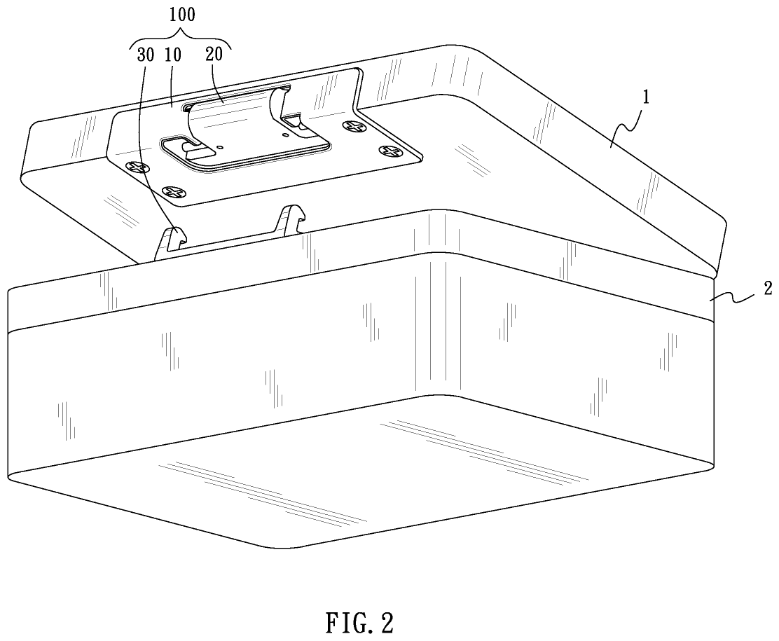

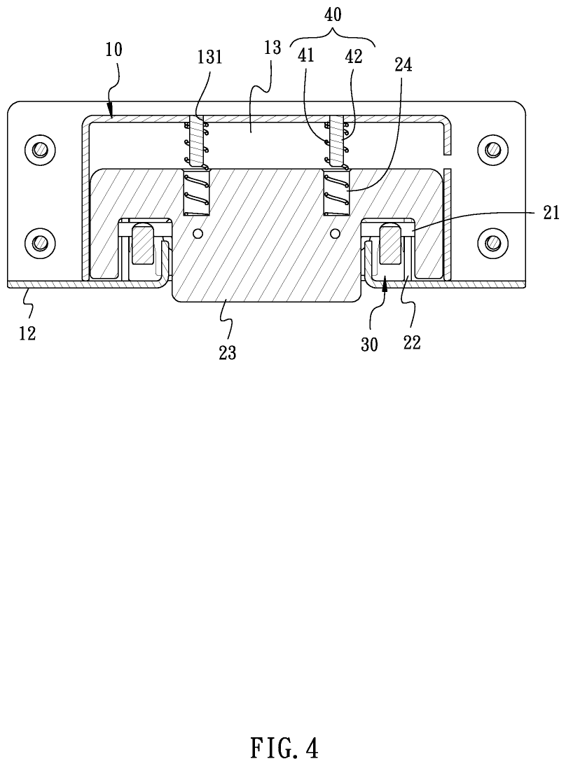

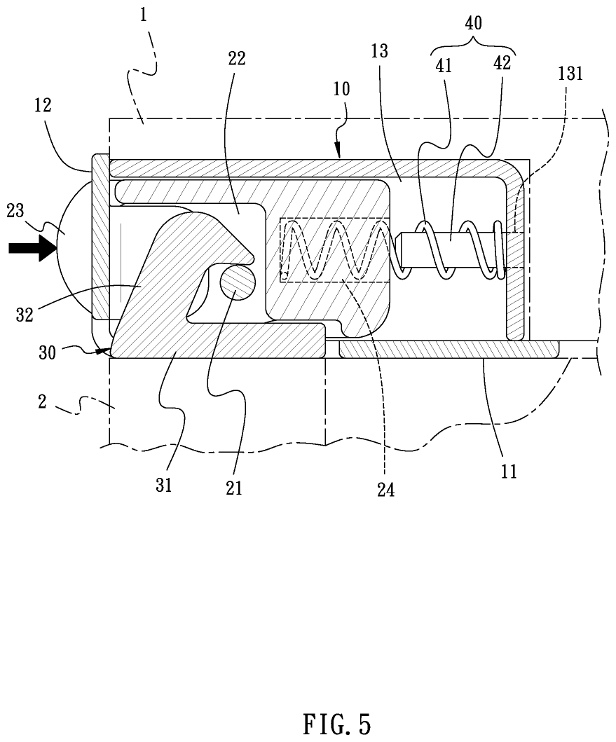

The moving member 20 is disposed in the containing groove 13 and movable between a first position and a second position with respect to the main body 10. The moving member 20 has at least an engagement portion 21. Also, the moving member 20 has at least a hook recess 22. In an embodiment of the present invention, two hook recesses 22 are included. The engagement portion 21 is a circular pin passing through the hook recesses 22, with an arc-shaped operation portion 23 disposed between the two hook recesses 22 and protruding therefrom. When the moving member 20 is at the first position, the operation portion 23 is exposed on the main body 10, as shown by FIG. 1, FIG. 2, FIG. 4, and FIG. 5.

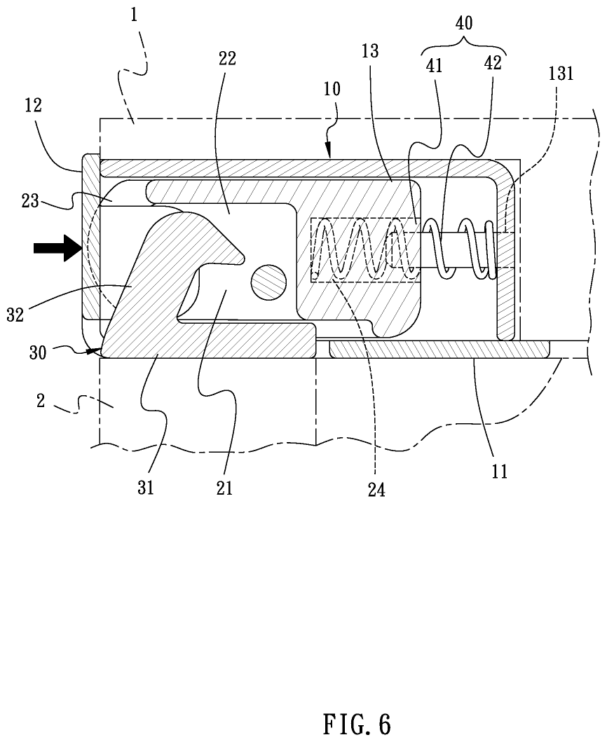

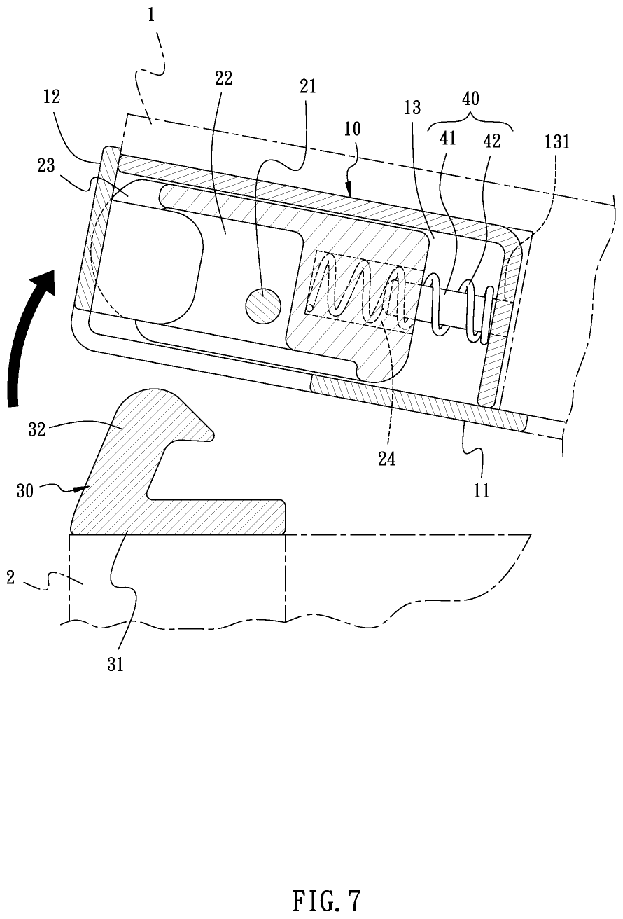

Further, the present invention includes a resilient assembly 40 disposed between the containing groove 13 and the moving member 20. When the moving member 20 is at the first position, the resilient assembly 40 pushes the moving member 20 to be exposed from the main body 10. When the moving member 20 is at the second position, the resilient assembly 40 is imposed with an external force to be compresses, as shown by FIG. 6 and FIG. 7.

The resilient assembly 40 comprises at least a spring 41 and a positioning rod 42. The positioning rod 42 is mounted around the spring 41 and disposed between the moving member 20 and the inner wall of the containing groove 13. The spring 41 provides the resilient force to the moving member 20. The positioning rod 42 keeps the spring 41 from being deformed and biased during the operation. Therein, for maintaining the preferable operation status of the spring 41 and the positioning rod 42, a first positioning bore 131 disposed on the inner wall of the containing groove 13, such that the positioning rod 42 has one end thereof being inserted to be positioned in the first positioning bore 131. Also, the moving member 20 has a second positioning bore 24, such that another end of the positioning rod 42 and one end of the spring 41 being inserted to be positioned in the second positioning bore 24.

Therein, in an embodiment of the present invention, the resilient assembly 40 comprises two springs 41 and two positioning rods 42. Also, the first positioning bores 131 and the second positioning bores 24 are provided in an amount corresponding to the amounts of the springs 41 and the positioning rods 42, respectively.

The hook member 30 has a base 31 and at least a hook portion 32 disposed on the base 31. The base 31 of the hook member 30 is fixed to one side of the second member 2 through a screw member or a bolt, so as to be arrange in alignment with the moving member 20. Also, when the moving member 20 is at the first position, the hook portion 32 enters the hook recess 22 to hook the engagement portion 21, whereby the moving member 20 and the hook member 30 are engaged with each other, such that the first member 1 and the second member 2 are closed. At the same time, the base 31 fits in the opening of the containing groove 13 on the installation face 11. Also, the first member 1 and the second member 2 are closed with a flush junction face, achieving an aesthetic appearance of a closing structure. When the first member 1 is to be lifted or opened with respect to the second member 2, a force is imposed on the moving member 20, such that the moving member 20 slides from the first position to the second position, as shown by FIG. 6, so as to retract with respect to the main body 10. At the meantime, the moving member 20 is able to be disengaged with the hook member 30, such that the first member 1 is lifted of opened with respect to the second member 2, as shown by FIG. 7.

Furthermore, in an embodiment of the present invention, the moving member 20 has two engagement portions 21 and two hook recesses 22, with an arc shaped operation portion 23 disposed between the two hook recesses 22 and protruding therefrom. When the moving member 20 is at the first position, the operation portion 23 is exposed on the outer lateral face 12 of the main body 10. Also, the hook member 30 has two hook portions 32 corresponding to the hook recesses 22 of the engagement portion 21, providing a stable hooking effect with the first member 1 and the second member 2 are closed.

It is noted that the moving member 20 has two mark bores 14 at the same side with the installation face 11. The base 31 of the hook member 30 has two fix bores 33 corresponding to the mark bores 14, respectively. Also, the fix bores 33 are formed in a long shape. Therefore, the fix bores 33 allow the hook member 30 to be fixed at a correct position during the fastening operation.

During the installation process, the main body 10 is first fixed to the first member 1, and two pins are applied to pass through the two mark bores 14, such that the two pins are used to leave a mark on the second member 2 corresponding to the position of the first member 1. Therefore, the marks allow the user to correctly fix the hook member 30 to the second member 2 through screw members, so as to prevent the hook member 30 and the main body 10 from deviate with respect to each other, facilitating a stable engagement effect.

With the foregoing configuration, the user simply presses the moving member 20 to retract the moving member with respect to the main body 10, such that the engagement portion 21 is parted from the hook member 30. Then, the first member 1 is able to be lifted to open with respect to the second member 2, facilitating the convenience of usage. Also, without complex components, the present invention is structurally simple, so as to be suitable for application upon various storage cabinets, seats, or any other structures needed to be manually open on a boat, vessel, ship, or yacht.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A latch device disposed between a first member and a second member, the first member and the second member being pivotally combined, the latch device comprising:
a main body having one side thereof fixed to the first member, the main body having a containing groove opening toward an outer side;
a hook member fixed to the second member; and
a moving member disposed in the containing groove and slidably moving between a first position and a second position with respect to the main body;
when the moving member is at the first position, the moving member is engaged with the hook member, such that the first member and the second member close; when the moving member is at the second position, the moving member retracts with respect to the main body, such that the moving member is parted from the hook member, whereby the first member and the second member open.

2. The latch device of claim 1, further comprising a resilient assembly disposed between the containing groove and the moving member; when the moving member is at the first position, the resilient assembly pushes the moving member, such that the moving member is exposed on the main body; when the moving member is at the second position, the resilient assembly is compressed.

3. The latch device of claim 2, wherein the resilient assembly comprises a spring and a positioning rod, the positioning rod being mounted around the spring and disposed between the moving member and an inner wall of the containing groove.

4. The latch device of claim 3, wherein the inner wall of the containing groove has a first positioning bore, such that the positioning rod has one end thereof being inserted to be positioned in the first positioning bore, and the moving member has a second positioning bore, such that another end of the positioning rod and one end of the spring are inserted to be positioned in the second positioning bore.

5. The latch device of claim 1, wherein the moving member has an engagement portion, and the hook member has a hook portion for hooking the engagement portion.

6. The latch device of claim 5, wherein the moving member has a hook recess, and the engagement portion is a circular pin passing through the hook recess.

7. The latch device of claim 2, wherein the moving member has an arc-shaped operation portion exposed on the main body.

8. The latch device of claim 1, wherein the main body has an installation face fixed to the first member, the moving member has two mark bores disposed on a same lateral side of the installation face, the hook member has a base fixed to the second member and a hook portion disposed on the base, and the bas has two fix bores corresponding to the two mark bores.

9. The latch device of claim 2, wherein the resilient assembly comprises two springs and two positioning rods, such that the two positioning rods are mounted around the two springs and disposed between the moving member and an inner wall of the containing groove, respectively.

10. The latch device of claim 9, wherein an inner wall of the containing groove has two first positioning bores, such that the two positioning rods has one end thereof being inserted to be positioned in the two first positioning bores, respectively; the moving member has two second positioning bores, such that another end of the two positioning rods and one end of the two springs are inserted to be positioned in the two second positioning bores, respectively.

11. The latch device of claim 2, wherein the moving member has two engagement portion, and the hook member has two hook portions hooking the two engagement portions, respectively.

12. The latch device of claim 11, wherein the moving member has two hook recesses, with an arc-shaped operation portion disposed between the two hook recesses and exposed on the main body; the two engagement portions are a circular pin passing through the two hook recesses.

13. The latch device of claim 12, wherein the main body has an installation face and an outer lateral face vertically connected with the installation face, the operation portion protruding from the outer lateral face, the installation face fixed to the first member, the containing groove concavely disposed on the main body between the installation face and the outer lateral face.

14. The latch device of claim 13, wherein the hook member has a base fixed to the second member, and the two hook portions are disposed on the base, such that when the first member and the second member close, the base fits in an opening of the containing groove on the installation face.

15. The latch device of claim 14, wherein the moving member has two mark bores on a same lateral side with the installation face, and the base of the hook member has two fix bores corresponding to the two mark bores.
